(19) United States
(12) Patent Application Publication
(10) Pub. No.: US 2009/0244231 A1
(43) Pub. Date: Oct. 1, 2009

(54) INKJET PRINTER

(75) Inventors: Masaaki TSUJI, Wakayama (JP); Yasuhiro TANAKA, Wakayama (JP)

Correspondence Address: Studebaker & Brackett PC, 1890 Preston White Drive, Suite 105, Reston, VA, 20191, US

(73) Assignee: NORITSU KOKI CO., LTD., Wakayama (JP)

(21) Appl. No.: 12/403,958

(22) Filed: Mar. 13, 2009

(30) Foreign Application Priority Data
Mar. 26, 2008 (JP) 2008-079593

(51) Int. Cl. B41J 2/01

(52) U.S. Cl. 347/102

(57) ABSTRACT

An inkjet printer includes: a printing part including a print head for ejecting ink to paper to print an image on the paper; a drying part including a heater for drying the ink adhering to the paper printed by the print head; and an agitator for agitating the air in the space in the printing part during a warm-up operation involving raising the temperature of the heater.

### CROSS-REFERENCE TO RELATED APPLICATION

This application claims priority under 35 USC 119 to Japanese Patent Application No. 2008-079593 filed on Mar. 26, 2008, the entire contents of which are incorporated herein by reference.

### BACKGROUND

The techniques disclosed in this specification relate to inkjet printers that include: a printing part including a print head for ejecting ink to paper to print an image on the paper; and a drying part including a heater for drying the ink adhering to the paper printed by the print head.

Generally, inkjet printers include a printing part with a print head for ejecting ink to paper to print an image on the paper. The print head ejects ink to paper conveyed to the printing part by a paper conveyance mechanism while reciprocating along a direction (main scanning direction) orthogonal to the direction of paper conveyance (sub-scanning direction) and thereby prints an image (including characters; the same applies hereinafter) on the paper. The printed paper is output onto a paper output tray.

The conventional inkjet printers include those, as disclosed for example in Published Japanese Patent Application No. 2001-270089, which include a drying part including: a heating roller; an infrared heater; and an air nozzle in order to dry ink adhering to printed paper. The drying part promotes the drying of ink by heating the paper surface with the heating roller and the infrared heater and blowing air through the air nozzle onto the paper surface. The inkjet printer in the publication further includes a heat-transfer blocking means for hindering heat energy produced by the drying part from being transferred directly to the printing part.

### SUMMARY OF DISCLOSURE

In inkjet printers having low printing speed, ink adhering to each printed piece of paper dries before the piece of paper is output to their paper output tray and, therefore, the ink need not be dried by heat. On the other hand, in printers having high printing speed, each printed piece of paper is output to their paper output tray before the ink dries by itself. Therefore, to prevent this, the ink adhering to the piece of paper must be dried by heat. The reason for this is that if a next printed piece of paper is laid on a previous printed piece of paper with ink thereon not yet dried, the next piece of paper brushes against the wet ink on the underlying previous piece of paper, whereby the print quality of the underlying piece of paper is deteriorated and the back of the overlying piece of paper is stained with ink adhering thereto. In addition, the next piece of paper overlaid on the previous piece of paper causes uneven dryness of ink adhering to the underlying previous piece of paper. Such uneven dryness also deteriorates the print quality. For these reasons, in printers having high printing speed, ink adhering to the printed piece of paper must be dried by heat.

To meet the above need, it is conceivable that such an inkjet printer having a high printing speed is provided with a drying part as disclosed in the above publication to dry ink adhering to the printed paper.

In such a case, however, heat produced by the drying part may be transferred to the space in the printing part to cause temperature variations in the space. Such temperature variations are likely to occur particularly during a warm-up operation involving raising the temperature of the heater, such as after power-on of the printer or the switch of the printer from a standby mode in which the heater is at low temperature to an operating mode in which the heater is at high temperature.

If temperature variations occur in the space in the printing part during the warm-up operation as described above, they are not eliminated for a while even after the warm-up operation. This causes the following problem. Specifically, the landing point at which ink ejected from the print head lands on paper varies depending on the temperature of an ink-flight space in which the ink travels towards the paper. Therefore, normally, the ink ejection timing is adjusted according to the temperature of the ink-flight space. In this adjustment, from the viewpoint of cost and other factors, the temperature of the space in the printing part is detected by a single temperature sensor and the detected temperature is taken as the temperature of the ink-flight space. Hence, if such temperature variations as described above occur, the temperature detected by the temperature sensor differs from the actual temperature of the ink-flight space. Furthermore, if the print head includes a plurality of head units arranged side by side in the direction of paper conveyance, the above temperature variations cause a temperature difference between an ink-flight space for a head unit close to the drying part and an ink-flight space for a head unit away from the drying part. This leads to misalignment between the landing points of ink from the plurality of head units and thereby deteriorates the print quality.

In this relation, the inkjet printer disclosed in the above publication includes the heat-transfer blocking means. However, it is difficult that the heat-transfer blocking means completely blocks heat transfer to the printing part. If it is possible, this causes increase in cost and space.

The present invention has been made in view of the foregoing points and, therefore, an object of the invention is that even if heat produced in the drying part during the warm-up operation is transferred to the space in the printing part, the occurrence of temperature variations in the space is prevented with a simple structure.

To attain the above object, what is provided is an inkjet printer including: a printing part including a print head for ejecting ink to paper to print an image on the paper; a drying part including a heater for drying the ink adhering to the paper printed by the print head; and an agitator for agitating the air in the space in the printing part during a warm-up operation involving raising the temperature of the heater.

With the above configuration, during the warm-up operation, the agitator agitates the air in the space in the printing part. Thus, the temperature of the space can be made uniform and the occurrence of temperature variations in the space can be prevented with a simple structure. As a result, upon printing after the end of the warm-up operation, no temperature variations occur in the space. Therefore, the temperature detected by a temperature sensor disposed such as on the print head can be approximately equal to the actual temperature of each ink-flight space. Furthermore, even if the print head includes a plurality of head units arranged side by side in the direction of paper conveyance, it can be prevented that a temperature difference occurs between the ink-flight spaces for the plurality of head units. Accordingly, the inkjet printer can maintain a good print quality.

In the above inkjet printer, preferably, the printing part further includes a platen and a suction device, the platen including a support surface for supporting the paper to be printed by the print head and suction holes opening on the support surface, the suction device being capable of sucking the paper on the support surface of the platen through the suction holes during printing of the print head to hold the paper on the support surface, and the agitator comprises the suction device and is configured to operate during the warm-up operation to suck the air in the space through the suction holes and thereby agitate the air in the space.

Thus, the suction device, which is used during printing to hold by suction the paper on the support surface of the platen, can function also as an agitator by operating it also during the warm-up operation. The suction device is originally used in order to ensure the flatness of the paper during printing and thereby enhance the print quality. In inkjet printers including such a suction device, the suction device can be used also as an agitator and, therefore, the occurrence of temperature variations in the space in the printing part can be prevented at low cost and with a simple structure.

Alternatively, the agitator may comprise a fan disposed in the space in the printing part.

Such a fan has a high degree of freedom of placement. Therefore, the fan can be easily disposed at a point where the air in the space can be effectively made uniform. This ensures that the inkjet printer maintains a good print quality.

### BRIEF DESCRIPTION OF THE DRAWINGS

FIG. 1 is a perspective view showing the appearance of an inkjet printer according to an example embodiment.

FIG. 2 is a perspective view showing the structure of the inkjet printer inside a housing.

FIG. 3 is a plan view showing the structure of the inkjet printer inside the housing.

FIG. 4 is a front view showing the structure of the inkjet printer inside the housing.

FIG. 5 is a left side view showing the structure of the inkjet printer inside the housing.

FIG. 6 is a back view showing the structure of the inkjet printer inside the housing.

FIG. 7 is a schematic diagram of the inkjet printer when viewed from the left of the housing, showing a conveyance path for printing paper.

FIG. 8 is a cross-sectional view showing the structure of a drying unit when viewed from the left of the housing.

FIG. 9 is a corresponding view of FIG. 7, showing another form of agitator.

### DETAILED DESCRIPTION

Example embodiments will be explained below with reference to the drawings. The following example embodiments are merely illustrative in nature and are not intended to limit the scope, applications and use of the invention.

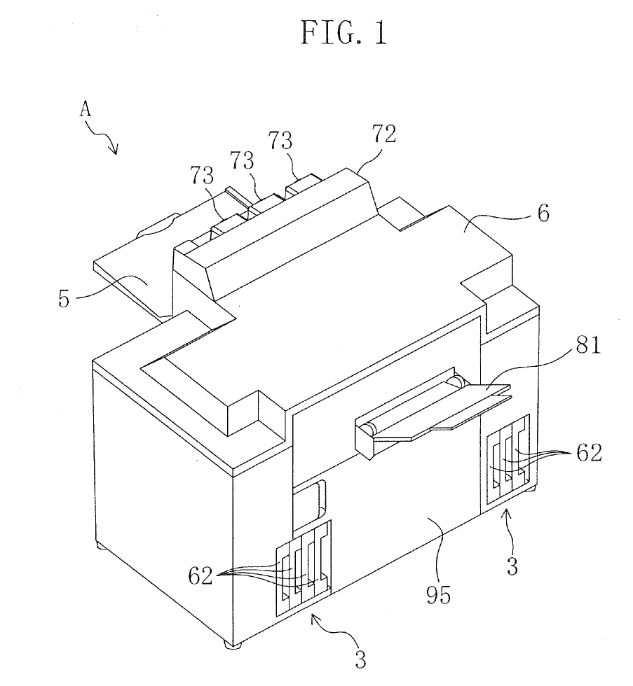

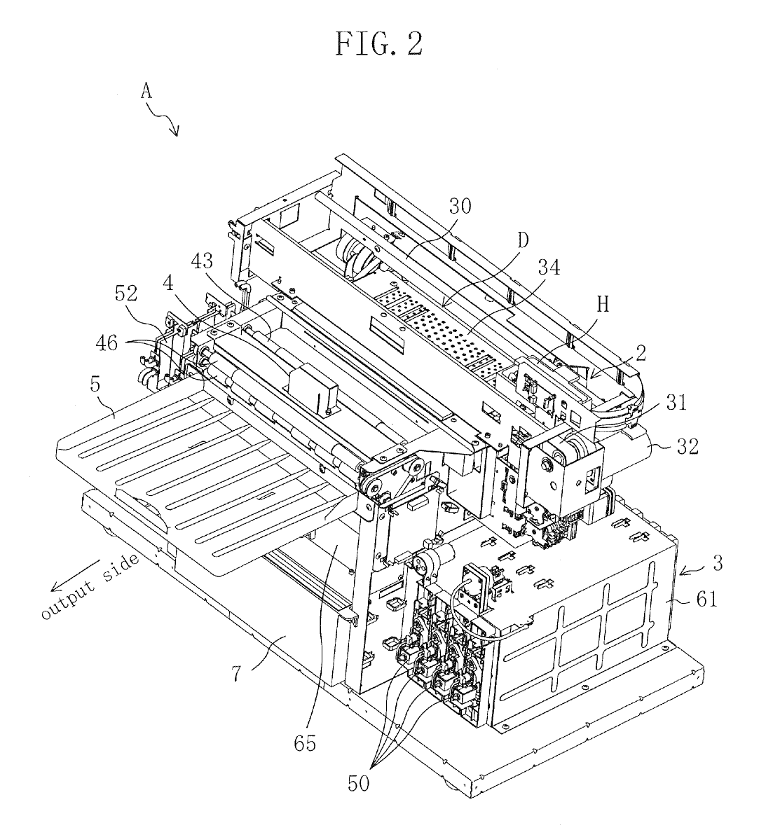

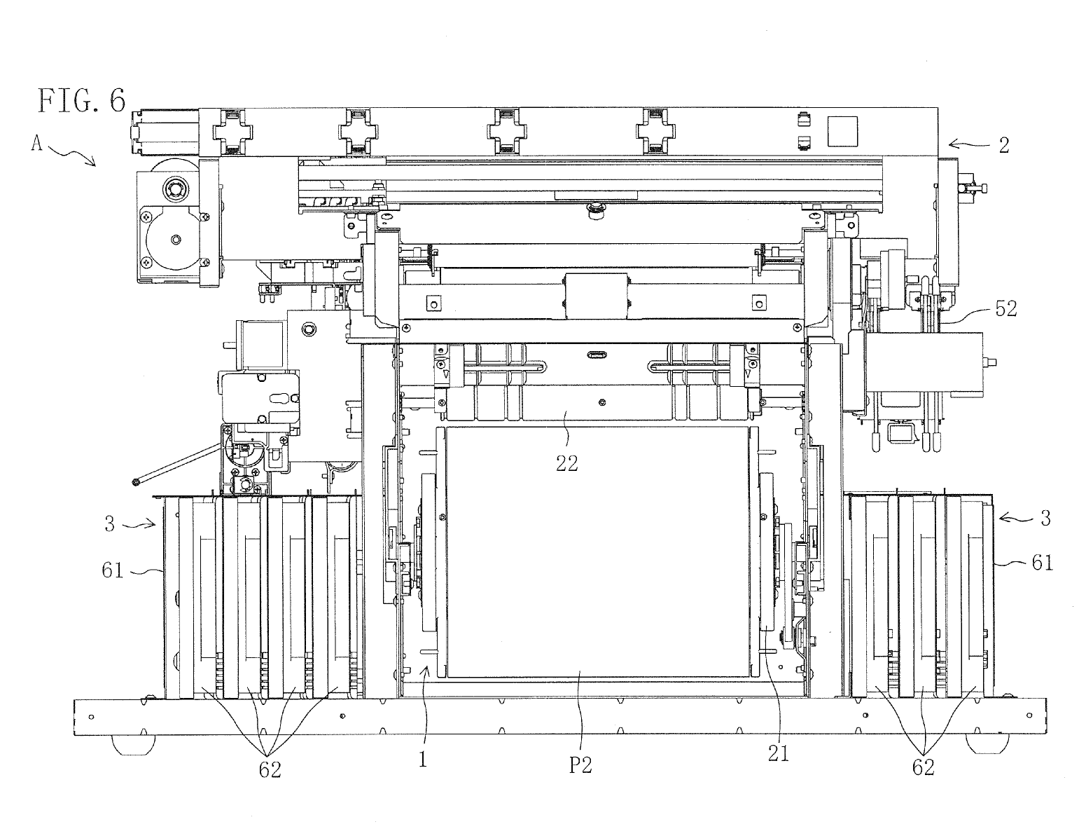

FIG. 1 shows the appearance of an inkjet printer A according to an example embodiment, and FIGS. 2 to 7 show the internal structure of the inkjet printer A. The inkjet printer A is used for a photographic printing system and, for example, used for printing photographic images on printing paper P1 or P2 based on image data transmitted via a communication cable from a reception block for obtaining the image data and correcting it as necessary. More specifically, the inkjet printer A can perform an automatic printing and a manual-feed printing. In the automatic printing, the inkjet printer A pulls out one end of a long roll of printing paper P2 and prints an image on the printing surface of the roll of printing paper P2 (hereinafter, referred to as a paper web P2). In the manual-feed printing, the inkjet printer A prints an image on the printing surface of a sheet of printing paper P1 (hereinafter, referred to as a paper sheet P1) previously cut in a given size.

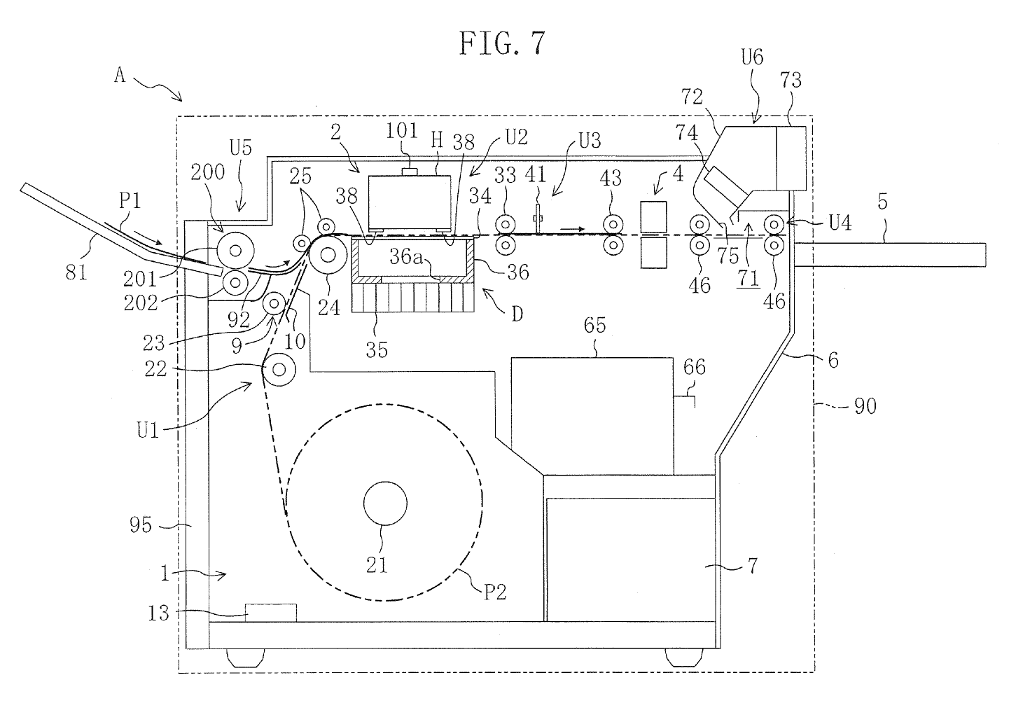

When in the following description the paper web P2 and the paper sheet P1 need not be particularly distinguished, they are referred to as printing paper P1 or P2. Furthermore, the printing surface means the surface on which an image is to be printed. The printing surface of each paper sheet P1 is determined when the paper sheet P1 is set on a manual-feed tray 81 (see FIG. 7). Specifically, the printing surface is the side of the paper sheet P1 facing upward when the paper sheet P1 is set on the manual-feed tray 81. On the other hand, the printing surface of the paper web P2 is the side thereof facing radially outward when the paper web P2 is rolled.

### General Structure

As shown in FIG. 7, the inkjet printer A includes a printer body 90 and a manual-feed tray 81 for manually setting a paper sheet P1 thereon and feeding it therefrom into the printer body 90. The printer body 90 includes: a housing 6; a paper roll containing part 1 in a lower part of the interior of the housing 6; a printing part 2 (see FIGS. 2 and 7) in an upper part of the interior of the housing 6 (above the paper roll containing part 1); ink storages 3 in the lower part of the interior of the housing 6 and on both sides of the paper roll containing part 1; and a roller unit 200 in the upper part of the interior of the housing 6. The paper roll containing part 1 contains a paper web P2 rolled with its printing surface outside. The printing part 2 prints, based on image data, an image on the printing surface of the paper sheet P1 fed from the manual-feed tray 81 or the printing surface of the paper web P2 pulled out of the paper roll containing part 1. The ink storages 3 store ink to be supplied to the printing part 2. The roller unit 200 is, more specifically, disposed on an upper part of a cover member 95 that is attached to the housing 6 to be freely opened and closed. With the cover member 95 closed, the roller unit 200 conveys and feeds a paper sheet P1 set on the manual-feed tray 81 towards the printing part 2.

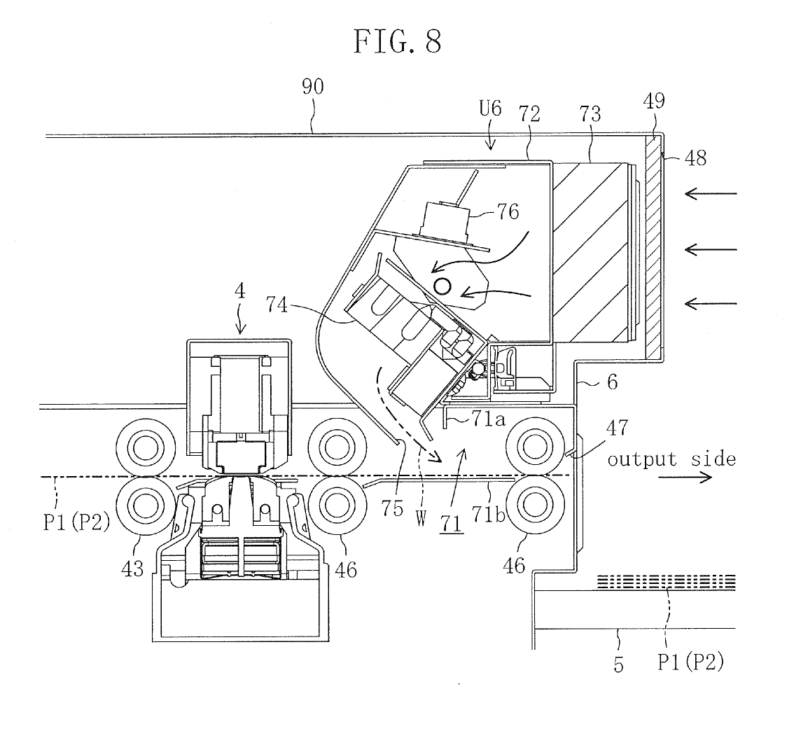

Disposed in the upper part of the housing 6 and downstream of the printing part 2 in the direction of paper conveyance are a cutter unit U3, a back printing unit 4, a drying unit U6 (corresponding to a drying part) and a paper output unit U4. The cutter unit U3 cuts off an unnecessary part of printed printing paper P1 or P2. The back printing unit 4 prints a serial number on the back side of each piece of printing paper P1 or P2. The drying unit U6 dries ink adhering to the piece of printing paper P1 or P2 printed in the printing part 2. The paper output unit U4 conveys the printed piece of printing paper P1 or P2 further downstream and outputs it. Disposed downstream of the paper output unit U4 in the direction of paper conveyance is the paper output tray 5 extending outside from a paper output port 47 (see FIG. 8) in the housing 6. The paper output tray 5 receives pieces of printing paper P1 or P2 delivered by the paper output unit U4 and placing them thereon.

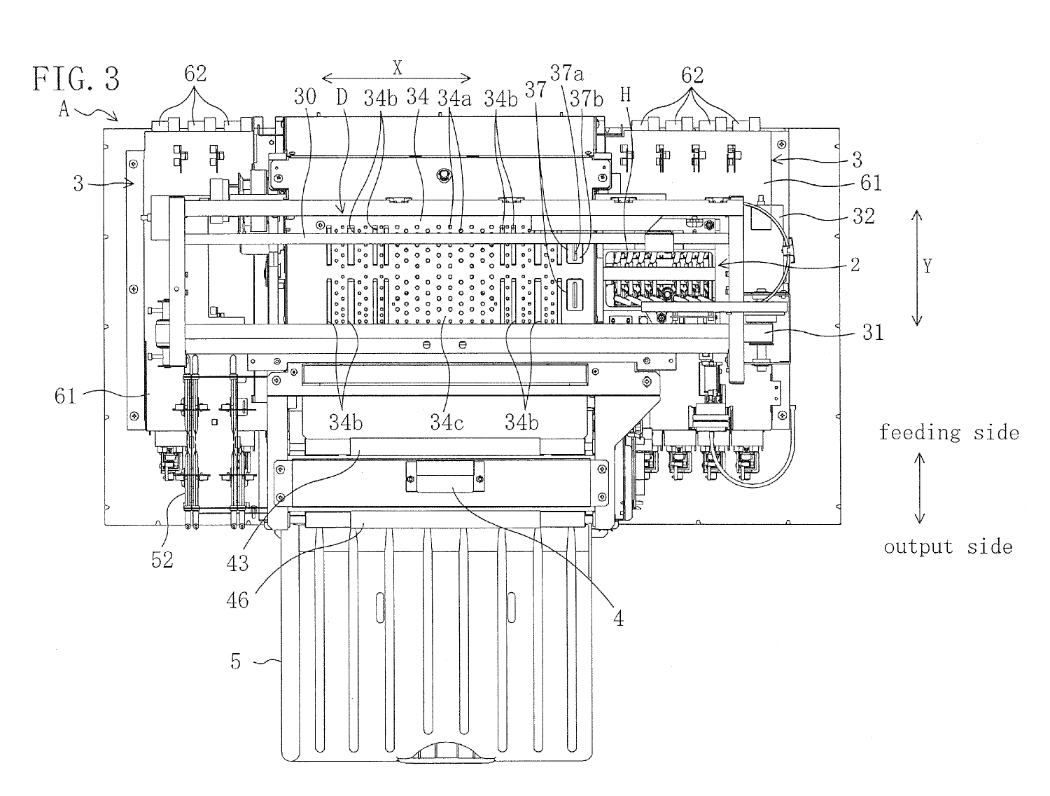

Hereinafter, the side of the housing 6 towards the paper output tray 5 (“output side” shown in FIG. 3) is referred to as the housing front side, the side thereof opposite to the paper output tray 5 (“feeding side” shown in FIG. 3) is referred to as the housing rear side, the left side thereof as viewed from the housing front side is referred to as the housing left side, and the right side thereof as viewed from the housing front side is referred to as the housing right side. Therefore, the right-to-left direction in FIG. 7 is the housing front-to-rear direction and the direction orthogonal to the drawing sheet of FIG. 7 is the housing right-to-left direction. The housing right-to-left direction coincides with the width direction of the paper sheet P1 set on and fed from the manual-feed tray 81 and the width direction of the paper web P2 contained in and fed from the paper roll containing part 1.

The printing part 2 includes a print head H (see FIGS. 2 to 4 and 7) for ejecting ink to the printing paper P1 or P2 to form an image on it. The print head II is configured to be movable along a rail 30 extending in a main scanning direction X (see FIG. 3) coinciding with the width direction of the printing paper P1 or P2 (i.e., the housing right-to-left direction). Specifically, when the rotational force of a drive motor 32 is transmitted through a pulley to a drive belt 31, the print head H moves in the main scanning direction X according to the amount of rotation of the drive belt 31.

The print head H further includes two head units 38 and 38 (see FIG. 7) arranged along a sub-scanning direction Y (see FIG. 3) orthogonal to the main scanning direction X and coinciding with the direction of travel of the printing paper P1 or P2 (i.e., the housing front-to-rear direction). The print head H is configured to print a given image on the printing paper P1 or P2 by ejecting ink through ink-jet nozzles (not shown) formed in these two head units 38 and 38.

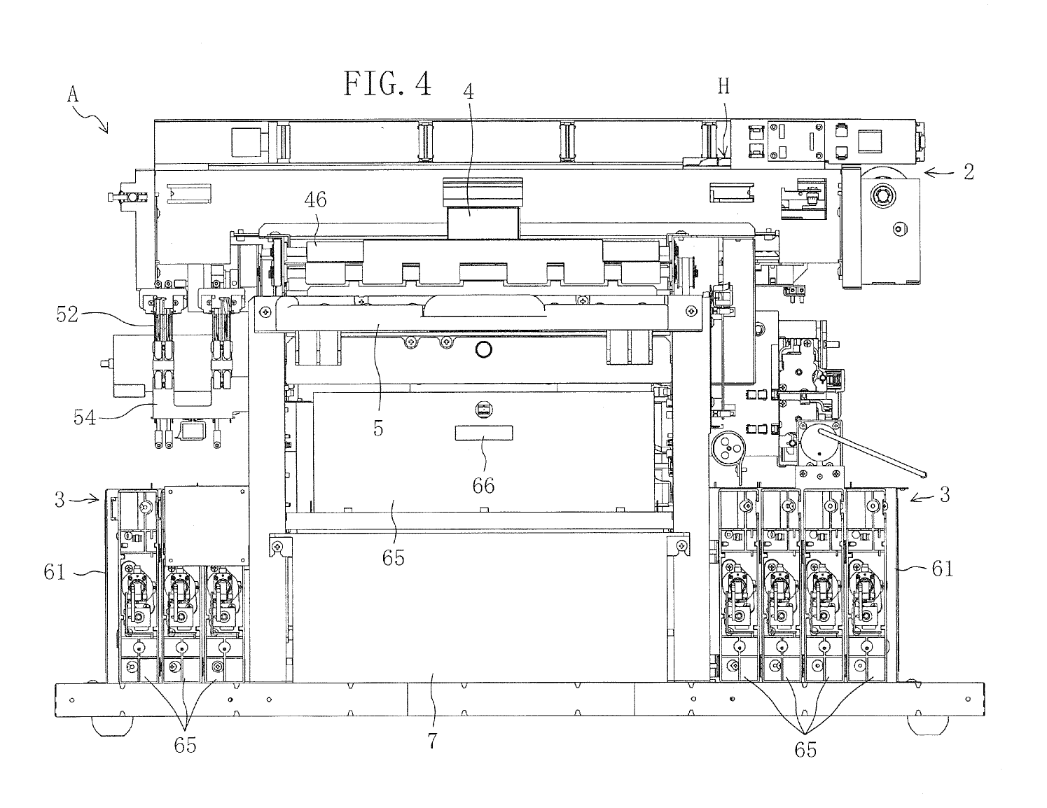

The ink storages 3 include their respective box-shaped cases 61 (see FIG. 4) disposed at both ends of the printer body 90 on the housing right and left sides. These cases 61 contain seven removable ink cartridges in total (in FIG. 4, three in the left case 61 and four in the right case 61). The ink cartridges 62 are charged with different types of ink having different hues. Therefore, the ink cartridges 62 spent or being used can be replaced with new ones by removing them from the cases 61 and setting new ones in the cases 61. Seven types of ink charged in these ink cartridges 62 are yellow (Y), magenta (M), cyan (C), black (K), red (R), violet (V) and clear (CL).

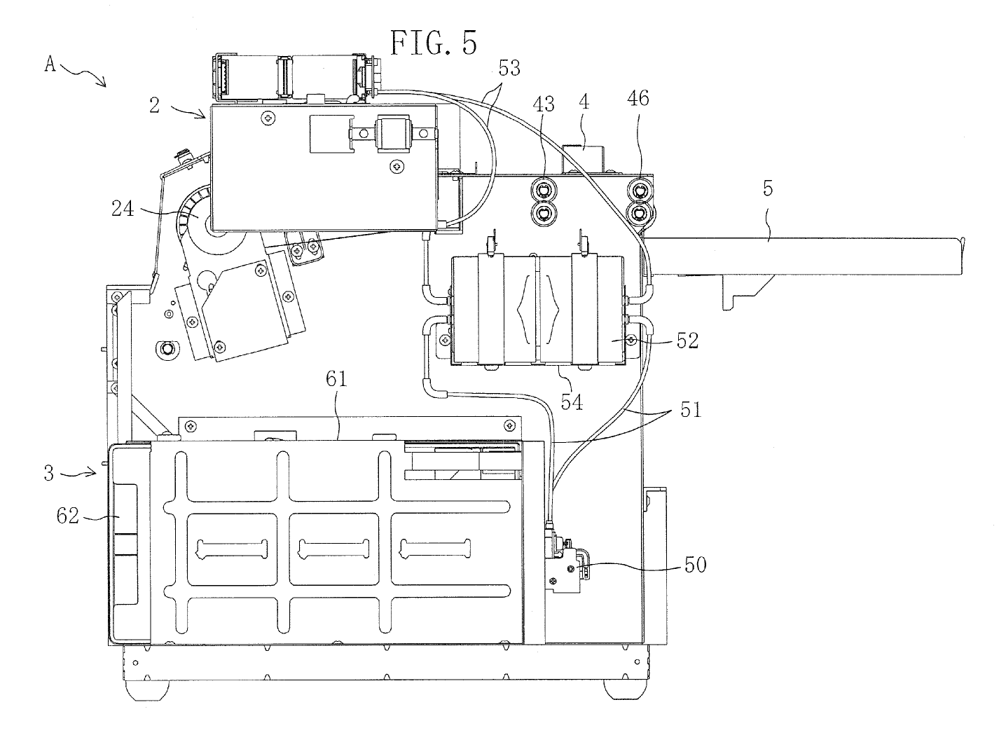

Furthermore, sub-tanks 52 (see FIGS. 4 and 5) are disposed at the end of the printer body 90 on the housing left side and at a height between the ink storages 3 and the printing part 2. The sub-tanks 52 temporarily store ink supplied from the ink cartridges 62. These sub-tanks 52 are connected to the print head H of the printing part 2 and configured to supply different types of ink therein to the print head H by negative pressure produced in ejecting the these types of ink through the associated nozzles of the print head H.

### Paper Conveyance Mechanism

As shown in FIG. 7, the inkjet printer A is provided with a paper conveyance mechanism for pulling the leading edge of a paper web P2 out of the paper roll containing part 1 and conveying it along a given conveyance path. To form the paper conveyance path, the paper conveyance mechanism includes, in order from the feed unit U1 for feeding a paper web P2, the feed unit U1, a printing unit U2, the cutter unit U3, the drying unit U6 (not shown in FIGS. 2 to 6) and the paper output unit U4. Thus, image data is printed on the printing surface of the printing paper P1 or P2 located on the paper conveyance path in the printing unit U2 provided in the printing part 2.

In this example embodiment, for another paper feed path other than the feed path of a paper web P2 from the feed unit U1 to the printing unit U2, the paper conveyance mechanism further includes a manual-feed unit U5 configured to pull in a paper sheet P1 from the manual-feed tray 81 and feed it to the printing part 2.

In printing on a paper web P2, the paper conveyance mechanism feeds, through the feed unit U1, the paper web P2 set in the paper roll containing part 1 to the printing unit U2. Then, the printing unit U2 prints image data on the fed paper web P2 with the print head H while conveying the paper web P2. Thereafter, the paper conveyance mechanism coveys the printed paper web P2 to the cutter unit U3, the cutter unit U3 cuts the paper web P2 to a given print size, the drying unit U6 then dries the cut piece of paper web P2, and the paper output unit U4 conveys the cut piece of paper web P2 out to the paper output tray 5.

In printing on a paper sheet P1, the paper conveyance mechanism feeds, through the manual-feed unit U5, the paper sheet P1 set on the manual-feed tray 81 to the printing unit U2, and then performs in the same manner as in the case of a paper web P2. However, in the case of a paper sheet P1, the cutter unit U3 normally does not cut it.

The manual-feed unit U5 includes the roller unit 200 for guiding the paper sheet P1 to the printing part 2. The roller unit 200 includes a drive roller 202 and a driven roller 201. The manual-feed unit U5 guides the paper sheet P1 from the manual-feed tray 81 into the printer body 90 by driving the drive roller 202 into rotation with an unshown electric motor.

The feed unit U1 includes a core roller 21, a transverse restriction roller 22, a closing roller 23 described later, a conveyance drive roller 24 capable of being driven into rotation by an unshown electric motor, and two pinch rollers 25 disposed opposite to the conveyance drive roller 24. The core roller 21 is used to wind a paper web P2 in a roll thereon so that the paper web P2 can be contained in the paper roll containing part 1. The transverse restriction roller 22 restricts the transverse position of the paper web P2 pulled out of the core roller 21. The conveyance drive roller 24 conveys the paper web P2 with its rotation. The two pinch rollers 25 are engageable against the conveyance drive roller 24 to pinch the paper web P2 together with the conveyance drive roller 24.

The feed unit U1 is configured to pull the paper web P2 out of the paper roll containing part 1 and also feed it to the printing part 2 by the rotation of the conveyance drive roller 24. Although in this example embodiment the transverse restriction roller 22 is provided, a guide for restricting the transverse position of the paper web P2 may be provided instead.

The closing roller 23 is provided to ensure the airtightness of the paper roll containing part 1 and thereby prevent the interior of the paper roll containing part 1 from falling into a low-humidity condition. Specifically, the walls defining the paper roll containing part 1 need to have a paper lead-out opening 9 for leading the paper web P2 out of the paper roll containing part 1 to the other space of the interior of the housing 6 (i.e., the space thereof containing the printing part 2). If the paper lead-out opening 9 is always open, the airtightness of the paper roll containing part 1 cannot be ensured. Therefore, the paper lead-out opening 9 is provided with the closing roller 23 that closes the paper lead-out opening 9 to allow the paper web P2 to pass through it.

At least the outer peripheral part of the closing roller 23 is made of an elastically deformable material, such as foam including sponge or rubber. The closing roller 23 is configured to contact the paper web P2 passing through the paper lead-out opening 9 while elastically deforming radially inwardly and be thereby driven into rotation. During the contact, the paper web P2 is pressed against the guide member 10 disposed opposite to the closing roller 23 (but its pressing force is substantially small). Thus, the paper web P2 can pass through the paper lead-out opening 9 with little resistance from the closing roller 23 while the paper roll containing part 1 can keep its airtightness.

When the paper web P2 is not in the paper lead-out opening 9, the closing roller 23 is in contact with the guide member 10. Also in this case, the airtightness of the paper roll containing part 1 can be ensured. In the paper roll containing part 1 thus keeping airtightness, a container 13 containing water and opening at its top is disposed. The water in the container 13 liquefies into vapor, whereby the interior of the paper roll containing part 1 is efficiently humidified.

Thus, even if the inkjet printer A itself is put under low-humidity conditions for a long time, the interior of the paper roll containing part 1 can be kept at an appropriate humidity (where printing paper can be used within the relative humidity range of 30% to 75%, preferably 40% to 60%). This prevents the paper web P2 from producing such a curl that the widthwise middle of the paper web P2 rises on the printing surface side with respect to both widthwise ends thereof.

The conveyance drive roller 24 can be rotated forward by an unshown electric motor to pull the paper web P2 out of the paper roll containing part 1 and feed it to the printing part 2 and rotated backward by the electric motor to return the paper web P2 to the paper roll containing part 1.

Thus, the inkjet printer A can cut off the printed part of the paper web P2 into a given size by the cutter unit U3 downstream of the printing part 2 in the direction of paper conveyance, then return the remaining long paper web P2 after the cutting upstream and restart printing with the leading edge of the remaining paper web P2. Alternatively, the inkjet printer A can return the paper web P2 after the cutting into the paper roll containing part 1, feed a paper sheet P1 to the printing part 2 through the manual-feed unit U5 and print on it. Furthermore, in replacing the paper web P2 with new one, part of the paper web P2 pulled out of the paper roll containing part 1 can be returned into the paper roll containing part 1.

The printing unit U2 includes: the print head H; a paper holder D (see FIGS. 3 and 7); and a pair of paper conveyance rollers 33 disposed downstream of the paper holder D in the direction of paper conveyance and engaged against each other. The paper holder D holds by suction the printing paper P1 or P2 at a position allowing printing of the print head H. The conveyance drive roller 24 and the pinch rollers 25 in the feed unit U1 are used also as components of the printing unit U2 and act to convey the printing paper P1 or P2 in the printing unit U2.

The paper holder D includes a platen 34 and a suction device 35 (see FIG. 7). The platen 34 has a support surface 34c (see FIG. 3) for supporting the printing paper P1 or P2 thereon and a large number of suction holes 34a (see FIG. 3) opening on the support surface 34a. The suction device 35 is formed of a fan and, during printing of the print head H, sucks the printing paper P1 or P2 on the support surface 34c through the suction holes 34a to hold it on the support surface 34c. The two head units 38 and 38 of the print head H are disposed with a slight clearance above the support surface 34c of the platen 34 to face the support surface 34c and move in the main scanning direction X while keeping the clearance.

The platen 34 is composed of a plate material and its surface (top) provides the support surface 34c. Disposed on the back (bottom) of the platen 34 is a case 36 forming a space together with the platen 34. The suction device 35 is disposed under the case 36. The suction holes 34a pass through the platen 34 in the thickness direction and are communicated with the space in the case 36. The space in the case 36 is communicated through an opening 36a formed in the bottom of the case 36 with the inlet opening of the suction device 35. When the suction device 35 is activated, negative pressure is produced through the suction holes 34a on the support surface 34c of the platen 34, whereby the printing paper P1 or P2 is held on the support surface 34c of the platen 34 by suction. This ensures the flatness of the printing paper P1 or P2 during printing and thereby enhances the print quality.

As shown in FIG. 3, the support surface 34c of the platen 34 is provided with flashing parts 37, caps (not shown) disposed at a standby position of the print head H during deactivation of the inkjet printer A, and recesses 34b. The flashing parts 37 receives a small amount of ink ejected through the ink-jet nozzles in the head units 38 of the print head H to prevent the ink viscosity from increasing in printing. The caps are configured to cover the ink-jet nozzles in the head units 38 of the print head II to prevent the ink viscosity from increasing.

Each flashing part 37 includes an opening 37a (see FIG. 3) formed in the platen 34. Disposed below the flashing part 37 in the platen 34 is a case (not shown) forming a space communicated with the opening 37a. The case is communicated with a waste tank 7 (see FIGS. 2 and 7) disposed in the lower part of the inkjet printer A towards the housing front side. Furthermore, an ink absorbing material 37b made of sponge capable of absorbing ink is disposed in the opening 37a. The ink infiltrating the ink absorbing material 37b accumulates in the space in the case located below the associated flashing part 37. Thus, the ink ejected towards the openings 37a of the flashing parts 37 is led into the waste tank 7 after accumulating in the spaces in the cases.

Each cap, although not particularly shown in the figures, has a space that, when it covers the bottom surface of the print head H, is put under negative pressure to draw a slight amount of ink through the ink-jet nozzles into the space. Thus, it can be prevented that the ink in the ink-jet nozzles becomes difficult to eject due to increase in its viscosity.

The recesses 34b are provided in order that, during production of borderless prints in which an image is printed on the printing paper P1 or P2 from widthwise edge to edge, even if part of ink ejected from the print head H (heat units 38) runs off the widthwise edges of the printing paper P1 or P2 on the support surface 34c of the platen 34, the support surface 34c is prevented from being contaminated with the run-off ink. Therefore, the recesses 34b are formed at points in the support surface 34c corresponding to the widthwise edges of the printing paper P1 or P2 put on the support surface 34c and corresponding to each head unit 38 in the sub-scanning direction Y to extend along the widthwise edges (or extend in the sub-scanning direction Y). The widthwise edges of the printing paper P1 or P2 exist on both lateral sides thereof. The inkjet printer A according to this example embodiment supports four types of printing paper P1 or P2 having different widths and, therefore, the support surface 34c has eight recesses 34b for each head unit 38, four on each side.

Ink absorbing materials (not shown) made of sponge are fitted in the respective associated recesses 34b to extend along the widthwise edges of the printing paper P1 or P2 on the support surface 34c. The ink absorbing materials absorb ink ejected from the print head H (heat units 38) and then running off the widthwise edges of the printing paper P1 or P2 on the support surface 34c. The ink absorbed in the ink absorbing materials is collected into the waste tank 7.

The print head H includes two head units 38 having a plurality of ink-jet nozzles and disposed in two stages in the sub-scanning direction Y on the bottom thereof (the surface opposed to the platen 34), as described previously. However, the number of head units 38 is not necessarily two and may be one or may be three or more.

Both the head units 38 have the same structure and each of them is composed of seven nozzle arrays, arranged in the main scanning direction X, for ejecting different types of ink of different colors therefrom. In each nozzle array, ink-jet nozzles as described above are aligned in the sub-scanning direction Y Thus, each head unit 38 can make color images independently of the other. The printing paper P1 or P2 is intermittently (stepwise) conveyed in certain unit amounts of conveyance in the sub-scanning direction Y by the conveyance drive roller 24. During each stopping time of the printing paper P1 or P2 in the course of intermittent conveyance, the print head H scans one way (makes a forward scanning or a backward scanning) in the main scanning direction X. During the scanning, seven different types of ink of different colors are concurrently ejected through the associated ink-jet nozzles of each head unit 38 to the printing surface of the printing paper P1 or P2. In other words, after a single scanning of the print head H, the printing paper P1 or P2 is conveyed by a unit amount of conveyance and the print head H then scans once. By repeating this operation, a desired image is printed. In this example embodiment, in order to eject ink from the print head H, common piezoelectric technology is employed in which the volume of a pressure chamber charged with ink is changed by a piezoelectric element and ink is thereby ejected through the ink-jet nozzles communicated with the pressure chamber.

The landing point at which ink ejected from the ink-jet nozzles in each head unit 38 lands on the printing paper P1 or P2 varies depending on the temperature of the ink-flight space for the head unit 38. To cope with this, in this example embodiment, a single temperature sensor 101 (see FIG. 7) is disposed on the print head H to detect the temperature of the space in the printing part 2, the temperature detected by the temperature sensor 101 is taken as the temperature of the ink-flight space for each head unit 38 and the ink ejection timing of the head unit 38 is adjusted according to the detected temperature.

The point of placement of the temperature sensor 101 is not limited to on the print head H and may be anywhere if the temperature of the space in the printing part 2 can be detected. Particularly, according to this example embodiment, there is a high degree of freedom of placement of the temperature sensor 101 because the temperature of the space in the printing part 2 is made uniform as described later. However, particularly in part of the space in the printing part 2 within which the print head H moves, the temperature should preferably be made uniform. From this viewpoint, the temperature sensor 101 is preferably disposed on the print head H. The number of temperature sensors 101 provided is not necessarily one but a single temperature sensor 101 will suffice since the temperature of the space in the printing part 2 is made uniform. Furthermore, from the viewpoint of cost reduction, the number of temperature sensors 101 provided is preferably one.

The cutter unit U3 includes a disc-shaped roller cutter 41 and is configured to cut the printing paper P1 or P2 into a given size (length) by moving the roller cutter 41 in the width direction at an appropriate position of the length of the printing paper P1 or P2 while rotating the roller cutter 41.

Disposed below the roller cutter 41 is a chip collecting box 65 for collecting chips of the printing paper P1 or P2 formed by the cutting. The chip collecting box 65 is configured so that the operator can slide it frontward out of the housing 6 by pulling its handle 66 and take out the chips collected in it. The housing front side of the chip collecting box 65 is made of clear plastic material to allow visual check for collection of chips.

Furthermore, the cutter unit U3 is configured to convey the printing paper P1 or P2 to the paper output unit U4 by a pair of conveyance rollers 43 engaged against each other. The back printing unit 4 is disposed between the cutter unit U3 and the paper output unit U4. In the back printing unit 4, a serial number or the like is printed on the back (underside) of the printing paper P1 or P2 passing through it.

As shown in FIG. 7, the paper output unit U4 includes the two pairs of output rollers 46 and 46 for conveying the printing paper P1 or P2 and outputting it to the paper output tray 5. The conveyance rollers 43 and the output rollers 46 and 46 are synchronously driven into rotation by an unshown electric motor.

As shown in FIG. 8, the drying unit U6 is disposed between the two pairs of output rollers 46 and 46 in the paper output unit U4. The drying unit U6 is configured to dry ink adhering to the printing paper P1 or P2 printed by the print head H (ink ejected from the print head H) by blowing dry air W onto the printed printing paper P1 or P2. The drying unit U6 sucks air into the housing 6 through an air inlet 48 formed in the housing 6 above and in the vicinity of the paper output port 47, applies heat to the sucked air and blows out the air as dry air W. The air inlet 48 is provided with a dust collection filter 49 to prevent dusts in the air from being sucked into the drying unit U6.

The drying unit U6 includes a drying chamber 71 disposed on the conveyance path for the printing paper P1 or P2 and a dryer 72 for supplying dry air W to the drying chamber 71. The drying chamber 71 is defined by an upper partition wall 71a and a lower partition wall 71b that are disposed opposite each other with the printing paper P1 or P2 therebetween, and constitutes a retention space for retaining dry air W blown onto the printing paper P1 or P2 from the dryer 72.

The dryer 72 includes a plurality of intake fans 73 disposed in the housing 6 at laterally spaced intervals, a heater 74, an exhaust nozzle 75 disposed at the lower end of the dryer 72 and opening downstream in the direction of paper conveyance, and a safety thermostat 76. The intake fans 73 take air from the outside through the air inlet 48 in the housing 6 into the dryer 72. The heater 74 heats the air taken in by the intake fans 73. The exhaust nozzle 75 blows the dry air W heated by the heater 74 therethrough downstream in the direction of paper conveyance. The safety thermostat 76 detects the internal temperature of the dryer 72 and stops the heater 74 in time of necessity. Since the dryer 72 is thus configured so that the dry air W is blown downstream in the direction of paper conveyance, the period of time when dry air W blows onto the printing paper P1 or P2 can be extended. If dry air W is blown vertically onto the printing paper P1 or P2, it hits directly only on the surface of the printing paper P1 or P2 opposed to the outlet of the exhaust nozzle 75 of the dryer 72. On the other hand, when dry air W is blown downstream in the direction of paper conveyance, it can hit directly not only on the target printing paper P1 or P2 but also on the printing paper P1 or P2 travelling downstream in the direction of paper conveyance. This provides an extended drying time for each printing paper P1 or P2 and efficient drying.

### Ink Supply System

As shown in FIG. 5, the ink supply system for the inkjet printer A is configured to deliver ink in the ink cartridges 62 of the ink storages 3 disposed at both ends of the printer body 90 on the housing right and left sides via solenoid valves 50 and delivery tubes 51 to the sub-tanks 52 and supply the ink in the sub-tanks 52 via flexible tubes 53 to the print head H.

The ink is delivered from the ink cartridges 62 to the sub-tanks 52 by pressurized air supplied into the ink cartridges 62 by a pressure pump (not shown), and then flows from the sub-tanks 52 to the print head H by negative pressure produced in pressure chambers upon ink ejection through the nozzles of the print head H.

Each sub-tank 52 is formed in the shape of a bag using a flexible material such as a resin sheet. The number of sub-tanks 52 is seven to correspond to the number of ink types having different hues. The seven sub-tanks 52 are disposed at an appropriate height in relation to the print head H so that the ink can be supplied at an appropriate pressure to the print head H.

As described above, the ink in the ink cartridges 62 is once stored in the sub-tanks 52 and then supplied from the sub-tanks 52 to the print head H. Therefore, the ink cartridges 62 can be replaced without interruption of printing. Furthermore, since the sub-tanks 52 serve also as pressure dampers, this prevents that pressure variations caused in the ink cartridges 62 are directly transmitted to the print head H and also prevents that an excessive pressure acts on the print head H to cause problems, such as ink leakage.

### Warm-Up Operation

When the operator turns on the power switch of the inkjet printer A, the inkjet printer A warms up for a predetermined time. During this warm-up operation, the temperature of the heater 74 is raised. After the temperature rise, the heater 74 is held at a first predetermined temperature (for example, 80° C. to 90° C.). On the other hand, when the power switch is on but a printing process is not performed, the inkjet printer A according to this example embodiment can be set to a standby mode in which the heater 74 is held at a second predetermined temperature (for example, 40° C. to 45° C.) lower than the first predetermined temperature. Then, when the operator changes the inkjet printer A from the standby mode to an operating mode, the inkjet printer A warms up again. Also during this warm-up operation, the temperature of the heater 74 is raised. The above predetermined time is set to a period of time (for example, two minutes to three minutes) in which the temperature of dry air W blown from the exhaust nozzle 75 reaches a desired value. Furthermore, during the warm-up operation, the rollers of the paper conveyance mechanism (but only the rollers not engaged on the printing paper P1 or P2) are idly rotated. Thus, these rollers can smoothly rotate upon paper conveyance. After the above warm-up operation is completed, a printing process is performed.

During the warm-up operation, heat produced by the heater 74 is transferred through the outside wall of the dryer 72 to the space in the printing part 2. In addition, heat in the drying chamber 71 is transferred along the paper conveyance path to the space in the printing part 2. Therefore, during the warm-up operation and until a certain period of time after the end of the warm-up operation, temperature variations are likely to occur in the space in the printing part 2. In order to avoid the occurrence of such temperature variations, the inkjet printer A according to this example embodiment is configured to agitate, during the warm-up operation, the air in the space in the printing part 2, particularly the air in the space adjacent to the support surface 34c of the platen 34 on the print head H side (the space above the support surface 34c).

Specifically, the suction device 35, which is used to hold by suction the printing paper P1 or P2 on the support surface 34c of the platen 34 during printing, is operated also during the warm-up operation. During the warm-up operation, normally, no printing paper P1 or P2 exists on the support surface 34c. This is because when the power switch of the inkjet printer A is turned off or when the inkjet printer A is set to the standby mode, the paper web P2 after being cut by the cutter unit U3 is returned into the paper roll containing part 1. If the suction device 35 is operated during the warm-up operation, it can agitate the air in the space in the printing part 2 by sucking the air in the space through the suction holes 34a. Thus, the suction device 35 functions as an agitator for agitating the air in the space in the printing part 2.

Therefore, according to this example embodiment, since during the warm-up operation the air in the space in the printing part 2 is agitated by operating the suction device 35, the temperature of the space can be made uniform. Thus, the occurrence of temperature variations in the space can be prevented with a simple structure. If on the contrary the air in the space in the printing part 2 is not agitated, a temperature difference tends to occur between the ink-flight space for the head unit 38 close to the drying unit U6 and the ink-flight space for the head unit 38 away from the drying unit U6. This is highly likely to cause misalignment between the landing points of ink from the head units 38 and thereby deteriorate the print quality. In contrast, according to this example embodiment, since the air in the space in the printing part 2 is agitated to eliminate temperature variations in the space, the space as a whole has approximately the same temperature. Therefore, the temperature detected by the temperature sensor 101 can be approximately equal to the actual temperature of the ink-flight space for each head unit 38. As a result, the ink ejection timing of each head unit 38 can be appropriately set based on the temperature detected by the temperature sensor 101. Therefore, the inkjet printer A can maintain a good print quality.

Furthermore, since the suction device 35, as is provided also in conventional inkjet printers, is used as the agitator during the warm-up operation, the occurrence of temperature variations in the space in the printing part 2 can be prevented at low cost and with a simple structure.

The configuration of the present invention is not limited to that of the above example embodiment and the present invention encompasses various other configurations.

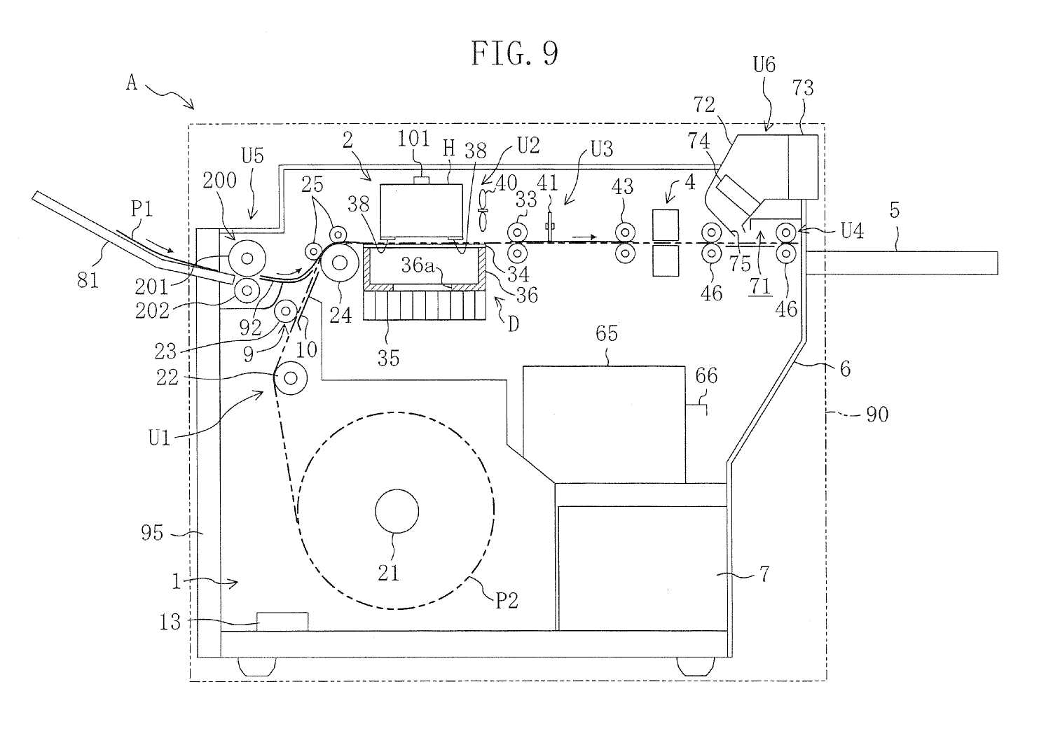

For example, although in the above example embodiment the agitator for agitating the air in the space in the printing part 2 is constituted by the suction device 35, the agitator can be constituted, as shown for example in FIG. 9, by another fan 40 disposed in the space in the printing part 2. Although in the example shown in FIG. 9 the fan 40 is disposed downstream of the print head II in the direction of paper conveyance, it may be disposed anywhere if the air in the space in the printing part 2 can be agitated to even out the temperature of the space. However, the fan 40 is preferably disposed to agitate the air in part of the space in the printing part 2 located adjacent to the support surface 34c of the platen 34 on the print head H side (located above the support surface 34c), particularly the air in part of the space within which the print head H moves. While during the warm-up operation the fan 40 is operated to agitate the air in the space in the printing part 2, the fan 40 is deactivated upon completion of the warm-up operation. Such a fan 40 has a high degree of freedom of placement. Therefore, the fan 40 can be easily disposed, in the space in the printing part 2, particularly at a point where the air in part of the space much desired to even out its temperature can be agitated. This ensures that the inkjet printer A maintains a good print quality.

Furthermore, although in the above example embodiment the print head H is provided with a temperature sensor 101 to adjust the ink ejection timing according to the temperature detected by the temperature sensor 101, an inkjet printer not performing such a timing adjustment may agitate the air in the space in the printing part 2. Thus, since during the warm-up operation the air in the space in the printing part 2 is agitated, the temperature of the space can be made uniform. This prevents that, during movement of the print head H in the main scanning direction X, the landing point of ink from the print head H on the printing paper P1 or P2 varies and also that a temperature difference occurs between the ink-flight spaces for the two head units 38 and 38 of the print head H. Therefore, a good print quality can be maintained.

What is claimed is:

1. An inkjet printer comprising:
a printing part including a print head for ejecting ink to paper to print an image on the paper;
a drying part including a heater for drying the ink adhering to the paper printed by the print head; and
an agitator for agitating the air in the space in the printing part during a warm-up operation involving raising the temperature of the heater.

2. The inkjet printer of claim 1, wherein
the printing part further includes a platen and a suction device, the platen including a support surface for supporting the paper to be printed by the print head and suction holes opening on the support surface, the suction device being capable of sucking the paper on the support surface of the platen through the suction holes during printing of the print head to hold the paper on the support surface, and
the agitator comprises the suction device and is configured to operate during the warm-up operation to suck the air in the space in the printing part through the suction holes and thereby agitate the air in the space.

3. The inkjet printer of claim 1, wherein the agitator comprises a fan disposed in the space in the printing part.
